(19) United States
(12) Patent Application Publication
(10) Pub. No.: US 2010/0032602 A1
(43) Pub. Date: Feb. 11, 2010

(54) GAS VALVE WITH AN IMPROVED VALVE CORE

(76) Inventors: Qibiao XIE, Zhongshan City (CN); Rui-Yuan HSIAO, Zhongshan City (CN)

Correspondence Address: MYERS WOLIN, LLC, 100 HEADQUARTERS PLAZA, North Tower, 6th Floor, MORRISTOWN, NJ, 07960-6834, US

(21) Appl. No.: 12/512,133

(22) Filed: Jul. 30, 2009

(30) Foreign Application Priority Data
Aug. 7, 2008 (CN) 200810030076.3

(51) Int. Cl. F16K 1/36

(52) U.S. Cl. 251/205

(57) ABSTRACT

A gas valve with an improved valve comprises a valve body, a valve seat, a hollow shaft and a valve core comprising an outer core and an inner core. The outer core is built with a higher fire orifice and a lower fire orifice. The inner core is built with two or more flow rate limiting orifices. To switch gas resources the nozzle can be replaced with a suitable one and regulated by using a screwdriver extending into the through bore and directly rotating the inner core, making the corresponding flow rate limiting orifice connect with the lower fire orifice. The gas flow rate in higher fire is controlled by the diameter of the nozzle and the gas flow rate is controlled by the corresponding orifices on inner core.

### CROSS REFERENCE TO RELATED APPLICATIONS

The present application claims priority to Chinese Application No. 200810030076.3 filed on Aug. 7, 2008, the disclosure of which is incorporated herein by reference in its entirety.

### BACKGROUND OF THE INVENTION

1. Field of the Invention

The invention relates to a gas valve, especially a gas valve with an improved valve core.

2. Description of the Related Art

Different kinds of gases have different characters such as heat load, combustion potential and wobbe index. Under the condition of producing a constant quantity of heat, the input of each kind of gases is very different. It is difficult to obtain high efficiency when a plurality of kinds of gases is used by the same valve. Traditionally each kind of valve is only used for one kind of gas, but it has to be replaced when another gas is to be used in order to obtain steady combustion. Such replacement brings much inconvenience to the manufacturer and the user, and causes resource waste. Moreover, if the user replaces the valve themselves, potential safety hazard exists and disaster can be caused.

### SUMMARY OF THE INVENTION

In order to overcome the above-described drawbacks of prior art, this invention provides a valve with an improved valve core, which has the feature of simple structure and can conveniently be used.

The invention designs a technology programme as follows:

A gas valve with an improved valve core, comprising a valve body and a valve seat, the valve body mating with the valve seat to form a cavity in which a valve core is fitted, the valve body comprising a gas input channel for connecting to a gas source and a gas output channel for connecting to a burner, and a nozzle being fitted at the end of the output channel, wherein the valve core comprises an outer core and an inner core inserted into said outer core, one end of the outer core is connected with a shaft inserted into said valve seat, on the end of the inner core, adjacent to the shaft, an regulating orifice is fitted in said inner core, on the shaft a through bore is made and connected to the regulating orifice, a restriction device is fixed to the inner core to restrict its movement along the axis, on the outer core a higher fire orifice and a lower fire orifice are made and connected with the gas output channel and the gas input channel, and two or more flow rate limiting orifices are made on the inner core, corresponding to a plurality of kinds of gas, wherein the diameters of the higher fire orifice and the lower fire orifice are equal to or greater than the designed maximum of the nozzle and the designed maximum of the flow rate limiting orifices.

As an improvement, the gas valve with an improved valve core of this invention are fitted with four flow rate limiting orifices, with an interval of 90 degrees between any two adjacent orifices, on the same circumference of inner core, the restriction device comprises an annular positioning groove fitted on the inner core, a pin hole set radially and connecting with the annular positioning groove, a stop pin inserted into the pin hole, with its tip thrusting into the annular positioning groove, further, a retainer groove is set, along the circumference in which the pin hole locates, on the outside surface of the outer core, a retainer ring is fitted in the retainer groove, and the stop pin, at the other end, presses against the inner side of retainer ring.

As a further improvement, the gas valve with an improved valve core of the invention are fitted with two flow rate limiting orifices, with an interval of 90 degrees, on the same circumference of inner core, the restriction device comprises a blind hole fitted on the inner core, a through hole set on the outer core, and a stop pin, one end of which is inserted into the blind hole and the other end is located in the stop pin of the through hole, and the two end sides of the through hole block the stop pin when the inner core is rotated so that the lower fire orifice connects with said two flow rate limiting orifices respectively.

The gas valve with an improved valve core of the invention are fitted with two flow rate limiting orifices, with an interval of 90 degrees, on the same circumference of inner core, the restriction device comprises a blind hole fitted on the inner core, a through hole set on the outer core, and a stop pin, one end of which is inserted into the blind hole and the other end is located in the stop pin of the through hole a sleeve clamp (27) is fixed on the outer core (14) where it is adjacent to the through hole (20) to prevent the stop pin (10) from dropping off, and the two end of the through hole (20) block the stop pin (10) when the inner core (12) is rotated so that the lower fire orifice (18) connects with said two flow rate limiting orifices (13) respectively.

The advantages from the invention are set forth below. The valve core comprises an outer core and an inner core inserted into the outer core, and the inner core is connected with a restriction device limiting movement along its axis and built with two or more flow rate limiting orifices corresponding to different gas resources. It only needs to replace the nozzle with a suitable one and rotate the inner core by using tools such as a screwdriver, extending into the through bore when switching the gas source. This makes a connection between the flow rate limiting orifices on the inner core and the lower fire orifice on the outer core. Because the diameters of the higher fire orifice and the lower fire orifice are equal to or greater than the designed maximum diameter of the nozzle and the designed maximum diameter of the flow rate limiting orifices, the gas flow rate in higher fire is controlled by the diameter of the nozzle and the gas flow rate controlled by the corresponding orifices on inner core. The invention is convenient, safe and reliable, and can be widely used in gas burners, gas barbecue, gas water heaters, etc. It can also achieve the objective of using two kinds of gas source and obtaining steady combustion by replacing the valve core, the shaft and the nozzle to improve traditional gas valves.

### BRIEF DESCRIPTION OF THE DRAWINGS

The invention will be detailed by reviewing the following description of the embodiment and accompanying drawings.

FIG. 1 is a perspective view of the overall valve of the invention;

FIG. 2 is a sectional view of a 360-degree rotary valve;

FIG. 3 is a perspective view of the inner core of a 90-degree rotary valve;

FIG. 4 is a perspective view of the outer core of a 360-degree rotary valve;

FIG. 5 is a perspective view of a 360-degree rotary valve core in exploded parts status;

FIG. 6 is a sectional view of the valve core of a 360-degree rotary valve;

FIG. 7 is a perspective view of a 360-degree rotary valve core in exploded parts status;

FIG. 8 is a sectional view of the valve core of a 90-degree rotary valve;

FIG. 9 is a sectional view along A-A in FIG. 6;

FIG. 10 is a sectional view along B-B in FIG. 8;

FIG. 11 is the plan view of an assembly of the outer core of 90-degree rotary valve and a limiting element;

FIG. 12 is a schematic diagram of a valve seat; and

FIG. 13 is a schematic diagram of a second valve core of the invention.

### DETAILED DESCRIPTION OF THE INVENTION

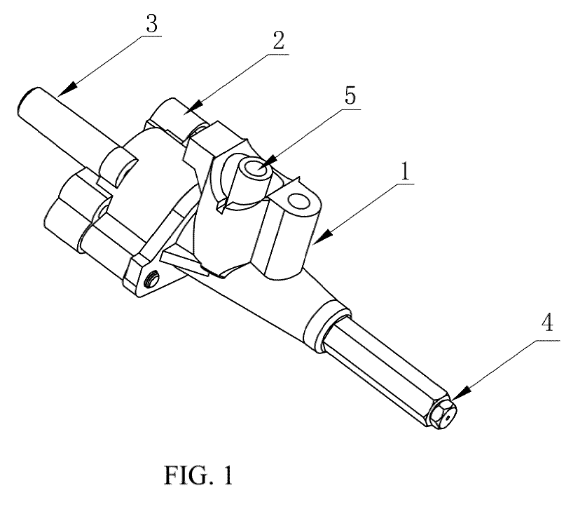

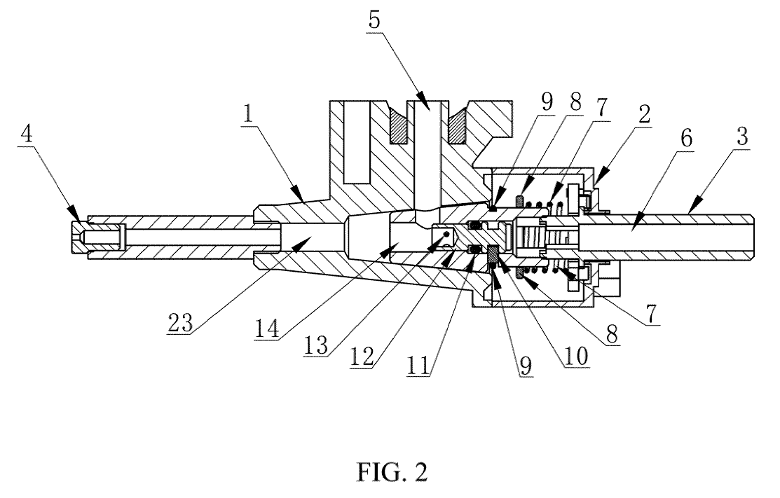

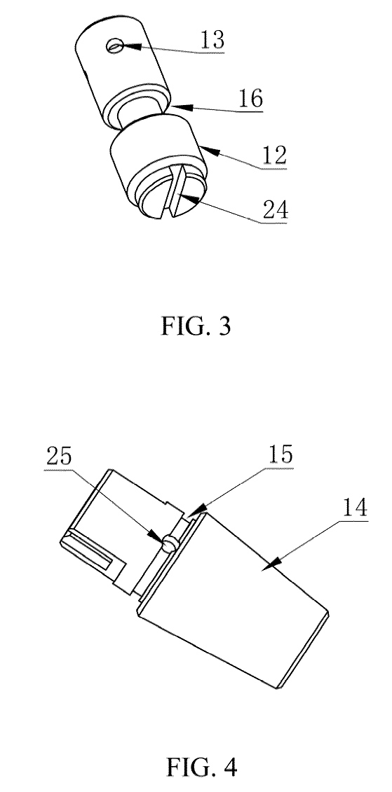

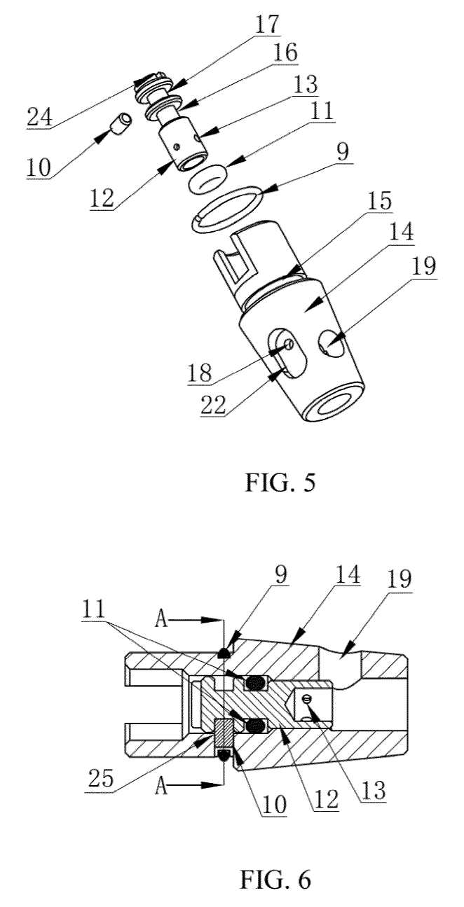

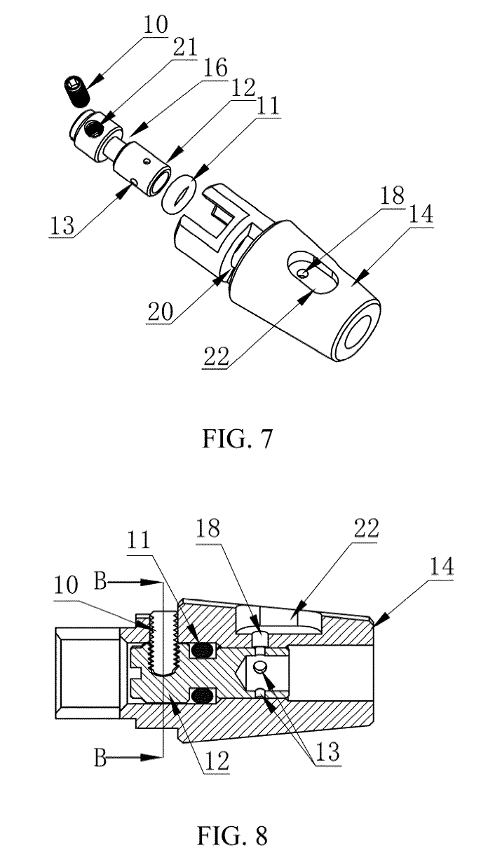

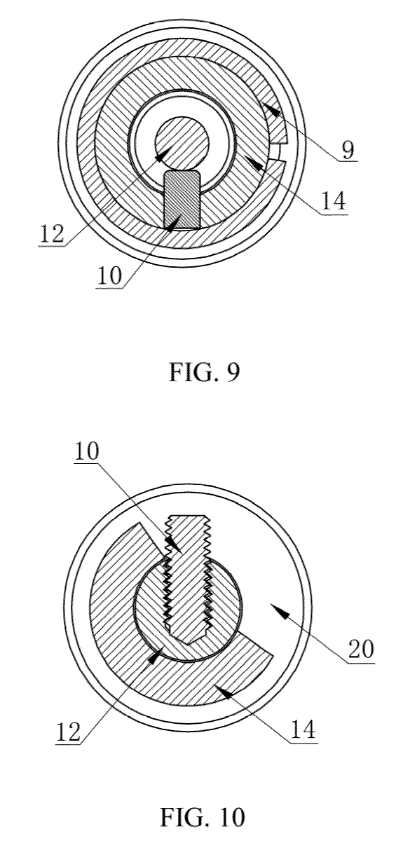

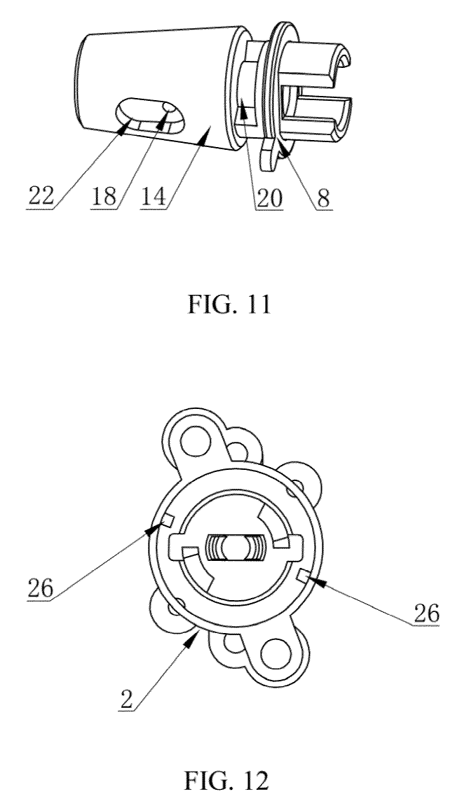

Please refer to FIG. 1 to FIG. 12, a gas valve with an improved valve core comprises a valve body 1 and a valve seat 2, the valve body 1 mates with the valve seat 2 to form a cavity in which a valve core is fitted, the valve body 1 comprises a gas input channel 5 for connecting to a gas source and a gas output channel 23 for connecting to a burner, and a nozzle 4 is fitted at the end of the output channel. The valve core comprises an outer core 14 and an inner core 12 inserted into said outer core. One end of the outer core 14 is connected with a shaft 3 inserted into said valve seat 2. A core spring 7 is set between the outer core 14 and the shaft 3. At the end of the inner core 12, adjacent to the shaft, an regulating orifice 24 is fitted in said inner core 12, and the regulating orifice 24 can be, for a screwdriver, a line groove or a cross groove. On the shaft 3 a through bore 6 is made and connected to the regulating orifice 24. The regulating orifice 24 can be regulated by directly rotating the inner core 12 using a screwdriver extending into the through bore 6. A restriction device is fixed to the inner core 12 to restrict its movement along the axis. On the outer core 14 a higher fire orifice 19 and a lower fire orifice 18 are made and connected with the gas output channel 23 and the gas input channel 5, and two or more flow rate limiting orifices 13 are made on the inner core 12, corresponding to a plurality of kinds of gas, wherein the diameters of the higher fire orifice 19 and the lower fire orifice 18 are equal to or greater than the designed maximum of the nozzle 4 and the designed maximum of the flow rate limiting orifices 13, that is to say, the flow rate passing through the higher fire orifice 19 and the lower fire orifice 18 are equal to or greater than the minimum designed flow rate of a higher fire and the minimum designed flow rate of a lower fire, respectively.

Further, the inner core 12 of the gas valve with an improved valve core of the invention has an annular seal neck 16, in which a seal ring 11 is mounted. After mounting, the two sides of the seal ring are abutted against the inner wall of the outer core 14, keeping gas from leaking.

The flow rate of a higher fire is determined by the diameter of nozzle 4, and the flow rate of a lower fire is determined by the flow rate orifice of inner core 12. When a higher fire is used, the input channel 5 is directly connected with output channel 23. It is possible to set the higher fire orifice 19 upstream the lower fire orifice 18, that is to say, the axis of the higher fire orifice 19 and the lower fire orifice 18 are fitted such that their axis are not located on the same circumference, then a recess 22 is built on the outside surface of the outer valve 14, which can provide a free connection from the gas input channel 5 to the lower fire orifice 18.

For convenient use, the gas valve with an improved valve core of the invention is built with a limit element 8 on the outer core 14 at its end connecting with the shaft 3, and two stops 26 are set on the valve seat 2 to limit rotating angle of the the limit element. The two stops 26 correspond to the higher fire orifice 19 and the lower fire orifice 18 and connect with input channel 5.

Commonly-used gases are methane and propane, so the gas valve with an improved valve core of the invention is built with four flow rate limiting orifices 13, with an interval of 90 degrees between any two adjacent orifices, on the same circumference of inner core 12, and the diameters of opposite orifices is equivalent. The restriction device comprises an annular positioning groove 17 fitted on the inner core 12, a pin hole 25 set radially and connecting with the annular positioning groove 17, and a stop pin 10 inserted into the pin hole 25, with its tip thrusting into the annular positioning groove 17. A retainer groove 15 is set, along the circumference which the pin hole 25 located in, on the outside surface of the outer core 14, a retainer ring 19 is fitted in the retainer groove 15, and the stop pin 10, at the other end, presses against the inner side of retainer ring 19. This makes assembling convenient and can make the valve core a 360-degree rotation, with the regulating orifice 24 of the inner core 12 positioned vertically or horizontally for two different gas resources.

Considering possible problems such as the flow rate limiting orifice 13 is not easy to direct at the lower fire orifice 18, which will produce a negative effect on combustion, the two flow rate limiting orifices 13 can also be fitted, with an interval of 90 degrees, on the same circumference of inner core 12. The restriction device comprises a blind hole 21 fitted on the inner core 12, a through hole 20 set on the outer core 14, and a stop pin 10, one end of which is inserted into the blind hole 21 and the other end is located in the through hole 20, and the two ends of the through hole 20 block the stop pin 10 when the inner core 12 is rotated so that the lower fire orifice 18 connects with said two flow rate limiting orifices 13, for the convenience of switching gas resources.

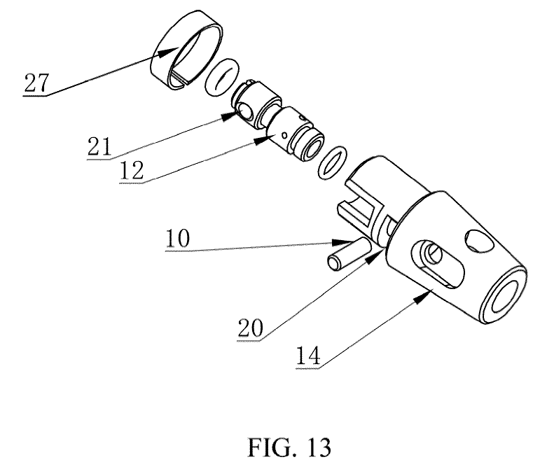

Please refer to FIG. 13, it is a schematic diagram of a second valve core of the invention. As shown, a gas valve with an improved valve core of the invention, wherein two flow rate limiting orifices 13 are fitted, with an interval of 90 degrees, on the same circumference of inner core 12, the restriction device comprises a blind hole 21 fitted on the inner core 12, a through hole 20 set on the outer core 14, and a stop pin 10, one end of which is inserted into the blind hole 21 and the other end is located in the through hole 20. A sleeve clamp 27 is fixed on the outer core 14 where it is adjacent to the through hole 20 to prevent the stop pin 10 from dropping off, and the two end of the through hole 20 block the stop pin 10 to limit the position of the stop pin when the inner core 12 is rotated. When the stop pin reaches each end of the through hole 20, the lower fire orifice 18 connects with said flow rate limiting orifices 13, respectively.

To switch gas resources, the nozzle can be replaced with a suitable one and regulated by using a screwdriver extending into the through bore and directly rotating the inner core, making the corresponding flow rate limiting orifice connect with the lower fire orifice. Because the flow rate passing through the higher fire orifice and the lower fire orifice are respectively equal to or greater than the minimum designed flow rate of a higher fire and the minimum designed flow rate of a lower fire, the gas flow rate in higher fire is controlled by the diameter of the nozzle and the gas flow rate is controlled by the corresponding orifices on inner core. The invention is convenient, safe and reliable to use, and can be widely used in gas burners, gas barbecue, gas water heaters, etc. It can also achieve the objective of using two kinds of gas source and obtaining steady combustion by replacing the valve core, the shaft and the nozzle to improve traditional gas valves.

What is claimed is:

1. A gas valve with an improved valve core, comprising: a valve body and a valve seat, the valve body mating with the valve seat to form a cavity in which a valve core is fitted, the valve body comprising a gas input channel for connecting to a gas source and a gas output channel for connecting to a burner, and a nozzle being fitted at the end of the output channel, wherein the valve core comprises an outer core and an inner core inserted into said outer core, one end of the outer core is connected with a shaft inserted into said valve seat, on the end of the inner core, adjacent to the shaft, an regulating orifice is fitted in said inner core, on the shaft a through bore is made and connected to the regulating orifice, a restriction device is fixed to the inner core to restrict its movement along the axis, on the outer core a higher fire orifice and a lower fire orifice are made and connected with the gas output channel and the gas input channel, and two or more flow rate limiting orifices are made on the inner core, corresponding to a plurality of kinds of gas, wherein the diameters of the higher fire orifice and the lower fire orifice are equal to or greater than the designed maximum of the nozzle and the designed maximum of the flow rate limiting orifices.

2. A gas valve with an improved valve core of claim 1, wherein an annular seal neck was made in said inner core, in which a seal ring is mounted.

3. A gas valve with an improved valve core of claim 1, wherein the higher fire orifice and the lower fire orifice are fitted such that their axis are not located on the same circumference, and a recess is built on the outside surface of the outer valve, which can provide a free connection from the gas input channel to the lower fire orifice.

4. A gas valve with an improved valve core of claim 1, wherein a core spring is set between the outer core and the shaft.

5. A gas valve with an improved valve core of claim 1, wherein a limit element is set on the outer core at its end connecting with the shaft, and two stops are set on the valve seat to limit the rotating angle of the limit element.

6. A gas valve with an improved valve core of claim 1, wherein four flow rate limiting orifices are fitted with an interval of 90 degrees between any two adjacent orifices, on the same circumference of inner core; the restriction device comprises an annular positioning groove fitted on the inner core, a pin hole set radially and connecting with the annular positioning groove, and a stop pin inserted into the pin hole, with its tip thrusting into the annular positioning groove.

7. A gas valve with an improved valve core of claim 6, wherein a retainer groove is set, along the circumference which the pin hole located in, on the outside surface of the outer core, a retainer ring is fitted in the retainer groove, and the stop pin, at the other end, presses against the inner side of retainer ring.

8. A gas valve with an improved valve core of claim 1, wherein two flow rate limiting orifices are fitted with an interval of 90 degrees on the same circumference of inner core, the restriction device comprises a blind hole fitted on the inner core, a through hole set on the outer core, and a stop pin, one end of which is inserted into the blind hole and the other end is located in the stop pin of the through hole, and the two end of the through hole block the stop pin when the inner core is rotated, so that the lower fire orifice connects with said two flow rate limiting orifices, respectively.

9. A gas valve with an improved valve core of claim 1, wherein two flow rate limiting orifices are fitted with an interval of 90 degrees on the same circumference of inner core, the restriction device comprises a blind hole fitted on the inner core, a through hole set on the outer core, and a stop pin, one end one end is inserted into the blind hole and the other end is located in the stop pin of the through hole, a sleeve clamp is fixed on the outer core where it is adjacent to the through hole to prevent the stop pin from dropping off, and the two end of the through hole block the stop pin when the inner core is rotated so that the lower fire orifice connects with said two flow rate limiting orifices respectively.
